(19) United States
(12) Patent Application Publication
(10) Pub. No.: US 2008/0309805 A1
(43) Pub. Date: Dec. 18, 2008

(54) IMAGE SENSOR PACKAGE

(75) Inventor: FU-CHIEH CHAN, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/944,318

(22) Filed: Nov. 21, 2007

(30) Foreign Application Priority Data
Jun. 14, 2007 (CN) 200710200820.5

(51) Int. Cl. H04N 5/335

(52) U.S. Cl. 348/294; 348/E05.091

(57) ABSTRACT

An image sensor package includes a printed circuit board (PCB) with a plurality of signal input pads disposed on an upper surface thereof, an image sensor chip, a frame layer, a transparent layer, a plurality of wires and glue. The image sensor chip includes a photosensitive region formed on a top surface thereof, a plurality of bonding pads formed on the periphery thereof, and a carrying region formed between the photosensitive region and the bonding pads. The glue covers a space formed between the PCB, the image sensor chip and the frame layer, for sealing the bonding pads, the input pads and the wires. The frame layer defines a base adhered to the corresponding carrying region and a window corresponding to the photosensitive region. The transparent layer is adhered to cover the window of the frame layer to seal the photosensitive region of the image sensor chip.

### FIELD OF THE INVENTION

The present invention relates to packaging of electronic components and, particularly, to an image sensor package with minimizing size.

### DESCRIPTION OF THE RELATED ART

Referring to FIG. 1, a related image sensor package 1 includes a printed circuit board (PCB) 4, an image sensor chip 3 defining a photosensitive region 6 on the middle portion thereof, a transparent layer 2 adhered upon the image sensor chip 3 via an adhesive (not labeled), and a plurality of wires 5. The image sensor chip 3 defines an upper surface (not labeled) formed with the photosensitive region 6 and a plurality of signal input pads 7 formed on the periphery of the photosensitive region 6, a bottom surface opposite to the upper surface adhered to the corresponding surface of the PCB 4 via an adhesive layer. The PCB 4 defines a plurality of terminals 8 connected to the corresponding input pads 7 of the image sensor chip 3 via the wires 5, thus a reliable electrical connection between the image sensor chip 3 and the PCB 4 is obtained.

When the image sensor chip 3 is engaged with a lens holder (not shown), the lens holder is adhered to a region of the PCB 4 formed surrounding the terminals 8 and the image sensor chip 3 via the adhesive layer. In this case, the size of the PCB 4 has to be enlarged to receive both the image sensor chip 3 and the lens holder. Consequently, the overall package volume for the image sensor chip 3 is large, thereby causing inconvenience in usage.

### SUMMARY OF THE INVENTION

In accordance with a present embodiment, an image sensor package includes a printed circuit board (PCB) defining a plurality of signal input pads on an upper surface thereof, an image sensor chip adhered to the PCB via adhesive layers, a frame layer, a transparent layer, a plurality of wires, and glue. The image sensor chip includes a photosensitive region formed on a top surface thereof, a plurality of bonding pads formed on the periphery of the image sensor chip, and a carrying region formed between the photosensitive region and the bonding pads. Each of the bonding pads is electrically connected to the corresponding signal input pads of the PCB by the wires. The glue covers a space formed between the PCB, the image sensor and the frame layer, for sealing the bonding pads, the input pads and the wires. The frame layer defines a base to adhere to the corresponding carrying region of the image sensor chip and a window corresponding to the photosensitive region. The transparent layer is adhered to cover the window of the frame layer to encapsulate, seal and protect the photosensitive region of the image sensor chip.

When the image sensor package engages with a lens holder, the lens holder is directly adhered to the frame layer and not the PCB, thereby the size of the PCB can be minimized. The image sensor package is for use with miniature lightweight electronic devices, which require thin and lightweight image sensor packages.

Those and other advantages and novel features will be more readily apparent from the following detailed description set forth below taken in conjunction with the accompanying drawings.

### BRIEF DESCRIPTION OF THE DRAWINGS

Many aspects of the present image sensor package can be better understood with reference to the following drawings. The components in the drawings are not necessarily drawn to scale, the emphasis instead being placed upon clearly illustrating the principles of the image sensor package. Moreover, in the drawings, like reference numerals designate corresponding parts throughout the several views.

FIG. 1 is a cross-sectional view of a related image sensor package;

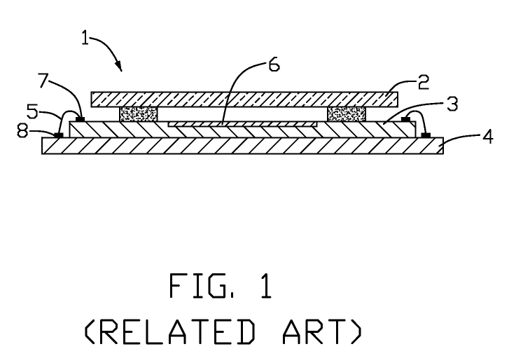

FIG. 2 is a cross-sectional view of an image sensor package in accordance with a first preferred embodiment; and

FIG. 3 is a cross-sectional view of another image sensor package in accordance with a second preferred embodiment.

### DESCRIPTION OF THE PREFERRED EMBODIMENT

Embodiments of the present image sensor package will now be described in detail below with reference to the drawings.

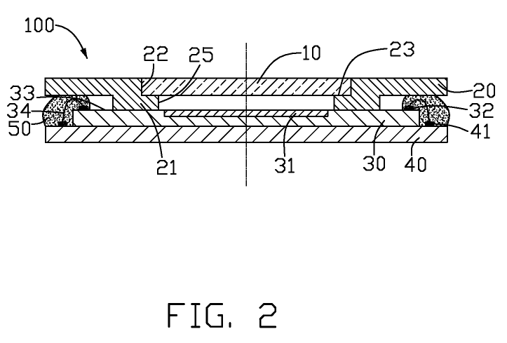

Referring to FIG. 2, an image sensor package 100, in accordance with a first preferred embodiment, includes a transparent layer 10, a frame layer 20, an image sensor chip 30 defining a photosensitive region 31 on the middle portion thereof, a plurality of wires 34, glue 50, and a printed circuit board (PCB) 40.

The image sensor chip 30 includes a plurality of bonding pads 32 formed at the periphery of the photosensitive region 31, and a carrying region 33 formed between the photosensitive region 31 and the bonding pads 32 for surrounding the photosensitive region 31.

The PCB 40 has an upper surface with a plurality of signal input pads 41 formed at the periphery thereof. The signal input pads 41 are electrically connected to the corresponding bonding pads 32 of the image sensor chip 30 by the wires 34.

The frame layer 20 is made from a plastic material and includes a base 21 to adhere to the corresponding carrying region 33 and a window, with a step-shaped configuration, corresponding to the photosensitive region 31 of the image sensor chip 30. The step-shaped window includes a first window 22 formed on an upper portion thereof, and a second window 25 coaxially formed on a lower portion thereof. The diameter of the first window 22 is larger than that of the second window 25 to form a middle surface 23 between the first window 22 and the second window 25. When the frame layer 20 is adhered onto the image sensor chip 30, and the sub-assembly of the frame layer 20 and the image sensor chip 30 is adhered onto the upper surface of the PCB 40, a space is formed between the sub-assembly of the frame layer 20 and the image sensor chip 30 and the PCB 40. The bonding pads 32 of the image sensor chip 30, the input pads 41 of the PCB 40, and the wires 34 are disposed in the space.

The glue 50 is made from silicone, epoxy, acrylic, or silver colloid. The space formed between the frame layer 20, the image sensor chip 30 and the PCB 40 is fully filled with the glue 50 which covers the bonding pads 32, the input pads 41 and the wires 34 for sealing and protecting them.

The transparent layer 10 is a piece of transparent glass adhered onto the middle surface 23 of the window and fixed in the first window 22 by an adhesive (not shown) so that the transparent layer 10 is coplanar with the upper portion of the frame layer 20. The image sensor chip 30 may receive optical signals passing through the transparent layer 10. In addition, the transparent layer 10 also may be a transparent glue layer directly formed in the second window 25 of the frame layer 20 to cover the photosensitive region 31 of the image sensor chip 30 so that the image sensor chip 30 may receive optical signals passing through the transparent glue layer.

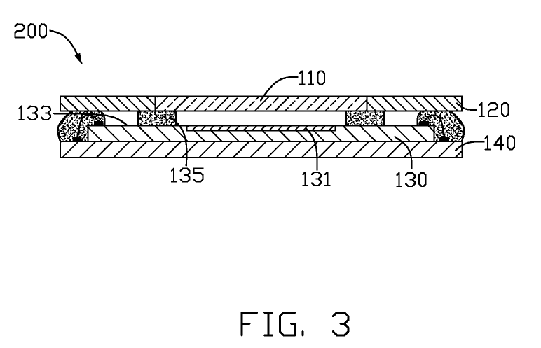

Referring to FIG. 3, another image sensor package 200, in accordance with a second preferred embodiment, is similar to that of the first embodiment. In this embodiment, the frame layer 120 is a plate-configuration and defines only one window in a middle portion thereof, and the carrying member 135 is made from resin or double-sided tape and separated from the frame layer 120 and disposed at the carrying region 133 of the image sensor chip 130. The transparent layer 110 is directly adhered in the window of the frame layer 120, and the sub-assembly of the transparent layer 110 and the frame layer 120 is adhered to the carrying member 135 to seal the photosensitive region 131 of the image sensor chip 130. Other configurations of the second embodiment are the same as that of the first embodiment, and so are not described in detail.

When the image sensor package is engaged with a lens holder (not shown), the lens holder is directly adhered onto the upper portion of the frame layer 20, 120 and the PCB 40, 140 does not remain a space to receive the lens holder, thereby the size of the PCB is reduced. Thus, the overall volume of the image sensor package is minimized so that the image sensor package is well-suited for use with smaller and lighter weight electronic devices.

Although the present invention has been described with reference to particular embodiments, it is not to be construed as being limited thereto. Various alterations and modifications can be made to the embodiments without in any way departing from the scope or spirit of the present invention as defined in the appended claims.

What is claimed is:

1. An image sensor package comprising:
a printed circuit board having an upper surface with a plurality of signal input pads formed at a periphery thereof;
an image sensor chip adhered to the upper surface of the printed circuit board, the image sensor chip including a photosensitive region formed on a middle portion thereof, and a carrying region formed around the photosensitive region;
a frame layer adhered to the carrying region of the image sensor chip, comprising a window corresponding to the photosensitive region;
a transparent layer adhered to the window of the frame layer by an adhesive to cover the photosensitive region of the image sensor chip;
a plurality of wires electrically connected between the signal input pads of the printed circuit board and the image sensor chip;
a layer of glue disposed between the printed circuit board and the frame layer for sealing the wires.

2. The image sensor package as claimed in claim 1, wherein the image sensor chip includes a plurality of bonding pads formed on the periphery of the carrying region and electrically connected to the corresponding input pads by the wires.

3. The image sensor package as claimed in claim 2, wherein the window has a step-shaped configuration and includes a first window formed on an upper portion thereof, and a second window coaxially formed on a lower portion thereof.

4. The image sensor package as claimed in claim 3, wherein the diameter of the first window is larger than that of the second window to form a middle surface between the first window and the second window.

5. The image sensor package as claimed in claim 4, wherein a room is formed around the periphery of the image sensor chip between the frame layer and the printed circuit board, the layer of glue being disposed in the room.

6. The image sensor package as claimed in claim 5, wherein the transparent layer is a piece of transparent glass adhered to the middle surface of the window and fixed in the first window by an adhesive so that the transparent layer is coplanar with the upper portion of the frame layer.

7. The image sensor package as claimed in one of claims 6, wherein the glue is selected from the group consisting of silicone, epoxy, acrylic, and silver colloid.

8. The image sensor package as claimed in claim 1, wherein the frame layer is adhered to the carrying region of the image sensor chip by a carrying member which is separately formed from the frame layer and directly adhered to the carrying region of the image sensor chip and the frame layer.

9. The image sensor package as claimed in claim 8, wherein the carrying member is selected from one of resin and double-sided tape.

10. The image sensor package as claimed in claim 1, wherein the frame layer overlaps at least one part of the layer of glue at a direction parallel to the optical axis of the image sensor chip.

11. An image sensor package comprising:
a printed circuit board having an upper surface;
an image sensor chip adhered to the upper surface of the printed circuit board, the image sensor chip including a photosensitive region formed on a middle portion thereof, and a carrying region formed around the photosensitive region, a plurality of bonding pads disposed at the periphery of the photosensitive region, a plurality of signal input pads disposed at the periphery of the printed circuit board around the image sensor chip;
a frame layer configured to support a lens holder thereon adhered to the carrying region of the image sensor chip, the frame layer comprising a widow aligned with the photosensitive region;
a transparent layer fixed in the window of the frame layer to cover the photosensitive region of the image sensor chip;
a plurality of wires electrically connecting the bonding pads with the signal input pads;
a layer of glue disposed between the printed circuit board and the frame layer for sealing the wires, wherein
the periphery of the frame layer extends perpendiculary away from the optical axis of the image sensor chip to cover at least one part of the layer of glue.

12. The image sensor package as claimed in claim 8, wherein the window has a step-shaped configuration and comprises a large window formed on an upper portion thereof, and a small window coaxially formed on a lower portion thereof, the transparent layer being received in the large window.

13. The image sensor package as claimed in claim 8, wherein the frame layer is adhered to the carrying region of the image sensor chip by a carrying member which is separately formed from the frame layer and directly adhered to the carrying region of the image sensor chip and the frame layer.

14. The image sensor package as claimed in claim 13, wherein the carrying member is selected from one of resin and double-sided tape.

15. The image sensor package as claimed in claim 1, wherein a room is formed between the frame layer and the printed circuit board in a direction parallel to the optical axis of the image sensor chip, the layer of glue being disposed in the room.
